(19) United States
(12) Patent Application Publication
(10) Pub. No.: US 2013/0119052 A1
(43) Pub. Date: May 16, 2013

(54) IMAGE HEATING DEVICE

(71) Applicant: CANON KABUSHIKI KAISHA, Tokyo (JP)

(72) Inventor: Naoyuki Yamamoto, Kashiwa-shi (JP)

(73) Assignee: CANON KABUSHIKI KAISHA, Tokyo (JP)

(21) Appl. No.: 13/672,541

(22) Filed: Nov. 8, 2012

(30) Foreign Application Priority Data
Nov. 11, 2011 (JP) 2011-247814

(51) Int. Cl. H05B 6/06

(52) U.S. Cl. CPC H05B 6/06
USPC 219/660

(57) ABSTRACT

An electromagnetic induction heating type image heating device is capable of preventing image defects caused by an increase in the temperature of a non-sheet passing portion during thin paper passage, and uses a magnetic shunt alloy having a predetermined Curie temperature. The image heating device is configured to heat a material based on heat generated by an eddy current generated in a conductive member by inducing a magnetic field in a conductive member with a magnetic flux generation unit. The conductive member includes a magnetic shunt alloy whose composition is adjusted to have a predetermined Curie temperature. The image heating device includes a cooling device configured to cool an end portion of the conductive member. Consequently, the image heating device can increase a cooling effect by the cooling device during thin paper passage, in which a fixing temperature is lower than during plain paper passage.

### BACKGROUND OF THE INVENTION

1. Field of the Invention

The present invention relates to an image heating device capable of heating a toner image on a recording material. This image heating device is used in an image forming apparatus, such as a copying machine, a printer, and a facsimile. More particularly, the present invention relates to an electromagnetic induction heating type image heating device.

2. Description of the Related Art

Conventionally, electrophotographic image forming apparatuses have included an image heating device that heats and fixes on a recording material a toner image formed on the recording material. Generally, this image heating device includes an image heating member for heating the toner on the recording material, and a nip forming member that presses against the image heating member to form a nip portion through which the recording material is sandwiched and conveyed. The image heating device heats the toner image at the nip portion. Japanese Patent Application Laid-Open No. 59-33787 discusses an image heating device that uses electromagnetic induction heating to increase heat generation efficiency. This image heating device causes the image heating member to generate heat based on Joule heat, which is produced by skin resistance when an eddy current is flowed through the image heating member by magnetic flux from a coil.

However, when conveying a recording material with a narrow width to a nip portion, the temperature of a portion (a non-sheet passing portion) not in contact with the recording material on the end portion side in the width direction of the image heating member is higher than the temperature of a portion (a sheet passing portion) in contact with the recording material. More specifically, the thermal expansion of the image heating member is different between the non-sheet passing portion and the sheet passing portion of the image heating member. Consequently, since the movement velocity of the image heating member is different between the non-sheet passing portion and the sheet passing portion of the image heating member, when a recording material with a wide width is subsequently conveyed to the nip portion, the conveyance of the recording material may become unstable.

Japanese Patent Application Laid-Open No. 2000-39797 discusses an image heating device that adjusts the Curie temperature of the image heating member to around a predetermined fixing temperature to suppress an increase in the temperature of the non-sheet passing portion when a recording material with a narrow width is conveyed. By using a magnetic shunt alloy having a Curie temperature adjusted to a predetermined temperature, the image heating member can suppress the temperature from increasing to the predetermined temperature or more. Consequently, the temperature of the non-sheet passing portion can be suppressed from excessively increasing.

However, the heat generation efficiency of the image heating member tends to deteriorate when the temperature of the image heating member is around the Curie temperature. Therefore, to enable the image heating member to efficiently generate heat, it is desirable to adjust the image heating member so that the Curie temperature of the image heating member is higher than a target temperature for the image heating member to be set to heat an image on the recording material.

However, the following issues may occur if the above-described image heating member is used in an image heating device in which the target temperature of the image heating member is set to a low temperature when a recording material having a small heat capacity, such as thin paper, is conveyed to the nip portion.

Specifically, the temperature of the non-sheet passing portion increases to near the Curie temperature when a recording material with a narrow width is conveyed even if a low temperature is set for the target temperature. More specifically, the temperature difference between the sheet passing portion and the non-sheet passing portion is too great. Consequently, the stability of subsequent recording materials' conveyance properties may become unstable. One way to prevent this issue in advance would be to mitigate the increase in temperature of the non-sheet passing portion by increasing the time interval between recording materials. However, this results in a deterioration in productivity.

### SUMMARY OF THE INVENTION

The present invention is directed to an image heating device capable of, in a configuration that uses an image heating member having a set Curie temperature, reducing the temperature difference between a non-sheet passing portion and a sheet passing portion without a substantial deterioration in productivity when conveying a recording material with a narrow width even if a target temperature for the image heating temperature is reduced.

According to an aspect of the present invention, an image heating device includes a coil, an image heating member configured to generate heat by magnetic flux generated from the coil to heat an image on a recording material at a nip portion, wherein the image heating member includes a magnetic shunt alloy adjusted to have a predetermined Curie temperature, a nip forming member configured to form the nip portion with the image heating member, a controller configured to execute a first heating mode for heating a recording material having a first grammage at a first target temperature, which is lower than the Curie temperature, when the recording material having the first grammage is conveyed to the nip portion, and to execute a second heating mode for heating a recording material having a second grammage, which is less than the first grammage, at a second target temperature, which is lower than the first target temperature, when the recording material having the second grammage is conveyed to the nip portion, and a cooling device configured to cool an end portion of the nip forming member, wherein, in the first heating mode, the cooling device is stopped by the controller, and, in the second heating mode, if a predetermined recording material with a width narrower than a maximum width that is usable by the image heating device is conveyed to the nip portion, the cooling device is operated by the controller when a temperature at a predetermined position at an end portion of the image heating member reaches a pre-set temperature that is lower than the Curie temperature.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic configuration diagram of an image forming apparatus example according to a first exemplary embodiment of the present invention.

FIG. 2 is a cross-sectional view of a fixing device (an electromagnetic induction heating type heating device) according to the first exemplary embodiment of the present invention.

FIG. 3 is a front model view of the main components of the fixing device according to the first exemplary embodiment of the present invention.

FIG. 4 is a longitudinal front view of the main components of the fixing device according to the first exemplary embodiment of the present invention.

FIG. 5 illustrates the principles of heat generation by a fixing roller.

FIG. 6 illustrates the temperature characteristics of magnetic permeability of a magnetic body having a predetermined Curie temperature.

FIG. 7 is a flowchart according to the first exemplary embodiment of the present invention.

FIG. 8 illustrates another configuration example of the fixing device according to the first exemplary embodiment of the present invention.

FIG. 9 illustrates a configuration example of the fixing device according to the first exemplary embodiment of the present invention.

FIG. 10 is a cross-sectional view illustrating a configuration example of a fixing device according to a second exemplary embodiment of the present invention.

FIG. 11 is a front model view of the fixing device according to the second exemplary embodiment of the present invention.

### DESCRIPTION OF THE EMBODIMENTS

Various exemplary embodiments, features, and aspects of the invention will be described in detail below with reference to the drawings.

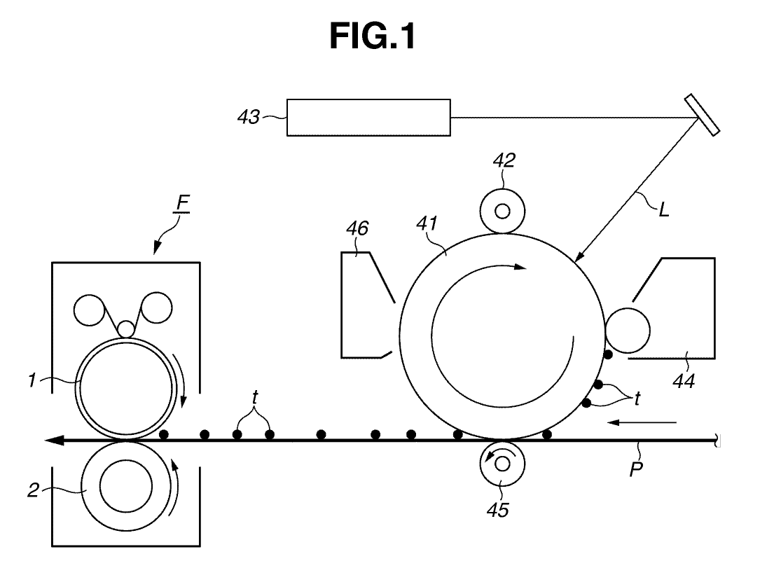

FIG. 1 is a schematic configuration model diagram illustrating an example of an image forming apparatus that includes an electromagnetic induction heating type image heating and fixing device according to a first exemplary embodiment of the present invention.

First, an image forming unit for forming a toner image on a recording material will be described. A rotating drum type photosensitive member (a photosensitive drum) 41 serving as an image bearing member is rotatably driven at a predetermined circumferential speed in the direction of the arrow. The photosensitive drum 41 is uniformly charged to a predetermined negative dark potential Vd by a primary charging device 42 during the course of rotation. A laser beam scanner 43 scans and exposes a uniformly charged face of the photosensitive drum 41 by outputting a laser beam L that is modulated based on a digital image signal input from a (not illustrated) host apparatus, such as an image reading apparatus or a computer. Due to this laser beam scanning and exposure, an exposed portion of the photosensitive drum 41 has a smaller absolute value of a potential, which is a light potential V1, so that an electrostatic latent image corresponding to the image signal is formed on the surface of the photosensitive drum 41. The electrostatic latent image is made visible as a toner image by adhering negatively-charged toner to the exposed portion having light potential V1 on the surface of the photosensitive drum 41 with a development unit 44.

On the other hand, a recording material P fed from a (not illustrated) paper feed tray is conveyed at an appropriate timing that is in synchronization with a rotation of the photosensitive drum 41 to a pressing portion (transfer portion) between a transfer roller 45, which acts as a transfer member to which a transfer bias is applied, and the photosensitive drum 41. A toner image t on the photosensitive drum 41 is sequentially transferred onto the surface of the recording material P. Then, the toner image t is subjected to fixing processing by separating the recording material P on which with the toner image t is formed from the photosensitive drum 41, introducing the recording material P to a fixing device F, which is a below-described image heating device, and applying heat and pressure. The thus-processed recording material P is then discharged from the device. Transfer residual matter, such as toner, remaining on the surface of the photosensitive drum 41 from which the recording material P has been separated is removed with a cleaning device 46, and the photosensitive drum 41 is again used to form images.

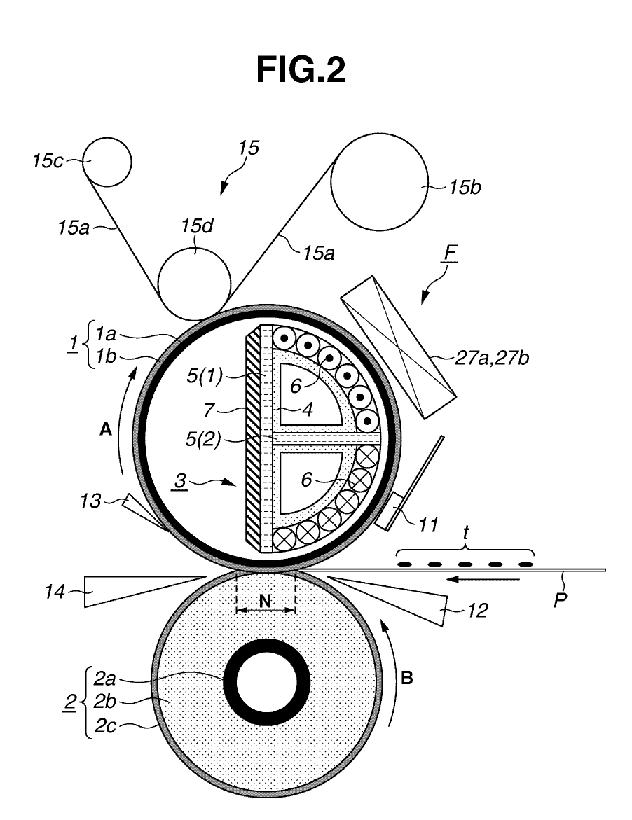

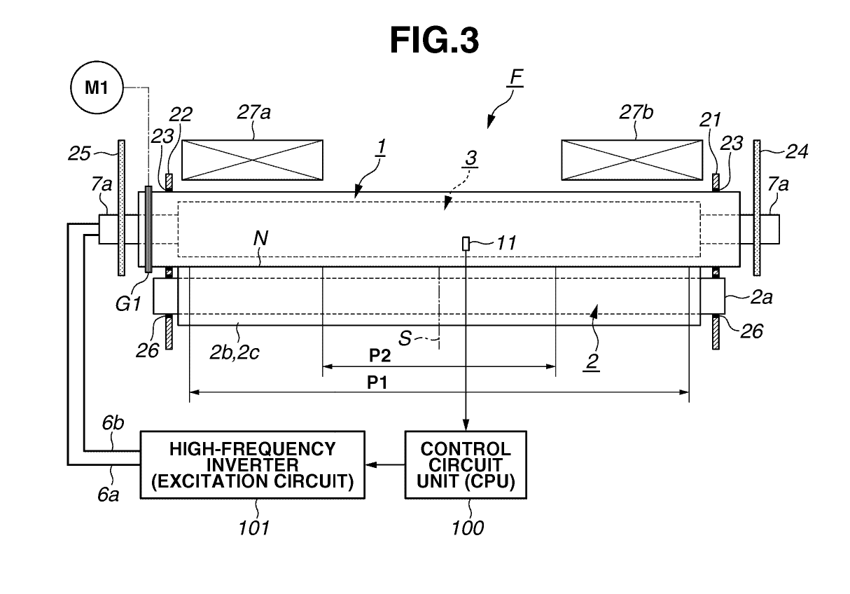

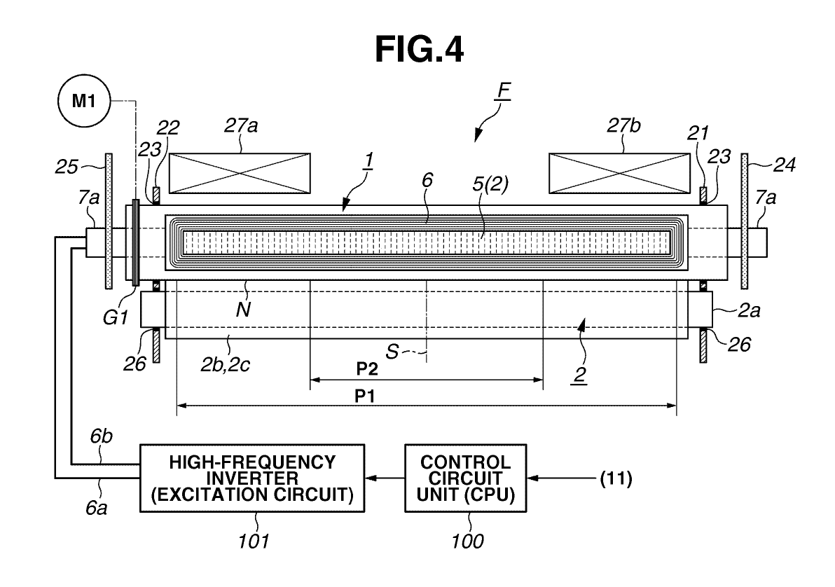

Next, the fixing device F acting as an image heating device will be described. FIG. 2 is an enlarged cross-sectional model view, FIG. 3 is a front model view, and FIG. 4 is a longitudinal front model view, respectively, of the main components of the fixing device F.

This fixing device F is a fixing roller type heating device that employs electromagnetic induction heating. The fixing device F includes a fixing roller 1 as an image heating member and a pressure roller 2 as a nip forming member that form a fixing nip portion N with a predetermined nip width (a nip length) by pressing against each other with a predetermined pressure.

The fixing roller 1 (the image heating member) has an external diameter of 40 mm, a thickness of 0.5 mm, and a length of 340 mm. A cored bar 1a of the fixing roller 1 (the image heating member) is formed from a magnetic shunt alloy that blends materials such as iron, nickel, and chromium, so that the Curie temperature Tc in the present exemplary embodiment is 220° C. Further, a surface layer 1b is formed from 30 μm-thick fluororesin such as perfluoroalkoxy (PFA) or polytetrafluoroethylene (PTFE) to increase the toner release properties. In addition, to obtain a high-quality fixed image of a color image or the like, a heat-resistant elastic layer of silicone rubber may be provided between the cored bar 1a and the surface layer 1b.

This fixing roller 1 is rotatably supported on either end portion side between side plates (fixing unit frames) 21 and 22, which are located at the front and rear sides of the fixing device F, respectively, via bearings 23. A coil assembly 3 is inserted in an inner hollow portion that acts as a magnetic flux generation unit for generating Joule heat by inducing an induced current (an eddy current) in the fixing roller 1.

The pressure roller 2 (the nip forming member) has an external diameter of 38 mm and a length of 330 mm. The pressure roller 2 includes a cored bar 2a having an external diameter of 28 mm and a thickness of 3 mm, a 5 mm-thick heat-resistant elastic layer 2b formed on the periphery of the cored bar 2a, and a 30 μm-thick surface layer 2c formed from fluororesin such as PFA or PTFE formed on the periphery of the heat-resistant elastic layer 2b.

This pressure roller 2 (the nip forming member) is arranged parallel with a lower side of the fixing roller 1, and is rotatably supported by both end portion sides of the cored bar 2a between side plates 21 and 22, which are located at the front and rear sides of the fixing device, respectively, via bearings 26.

The fixing roller 1 and the pressure roller 2 are made to press against each other countering the elasticity of the elastic layer 2b by a (not illustrated) pressing mechanism, and convey the recording material P as a material to be heated while sandwiching the recording material P between the rollers 1 and 2, thereby forming a fixing nip portion N with a width of about 5 mm for heating and fixing the toner image.

In the exemplary embodiments according to the present invention, the longitudinal direction of the device constituent members is the direction orthogonal to the conveyance direction of the recording material P in a plane including the fixing nip portion N (or the direction of the axis of the rotation of the fixing roller 1). Further, a center portion and an end portion are a center portion and an end portion in that longitudinal direction.

The coil assembly 3, acting as the magnetic flux generation unit, inserted into the inner hollow portion of the fixing roller 1 is an assembly configured from a bobbin 4, a magnetic core 5 (5(1) and 5 (2)), a coil 6, and a stay 7 formed from an insulating member. The core 5 is held in the bobbin 4. The coil 6 is formed from an electrical wire wound around the periphery of the bobbin 4. A unit configured from the bobbin 4, the core 5, and the coil 6 is fixedly supported by the stay 7.

The coil assembly 3 is inserted into the inner hollow portion of the fixing roller 1, and maintains a predetermined gap between an inner surface of the fixing roller 1 and the coil 6 at a predetermined angular orientation. In this state, the coil assembly 3 is fixedly supported on either side of an end portion 7a of the stay 7 in a non-rotatable manner on the holding members 24 and 25, which are located at the front and rear sides of the fixing device F, respectively.

The core 5 is a material having a high magnetic permeability and low residual magnetic flux density, such as ferrite or permalloy. The core 5 acts to guide magnetic flux generated by the coil 6 to the fixing roller 1. The core 5 in the present exemplary embodiment, which has a T shape in its cross-section, is configured by combining two plate-shaped cores 5 (1) and 5 (2) that form the crossbar portion and the vertical bar portion of the T shape.

As illustrated in FIG. 4, the coil 6 extends parallel in a longitudinal direction of the fixing roller 1, and is formed from a bundle of wound Litz wires that are folded at both ends and wound a plurality of times in an elongated boat shape to match the shape of the bobbin 4 to wrap around the core 5. Further, the coil 6 is bent to follow the inner periphery of the fixing roller 1. The coil 6 is also provided with two lead wires (coil supply wires) 6a and 6b, which are led externally out from the rear side of the stay 7 and are connected to a high-frequency inverter (an excitation circuit) 101 for supplying a high-frequency current to the coil 6.

A thermistor 11 acts as a temperature detection member (a temperature sensor) for detecting the temperature of the fixing roller 1. This thermistor will be described below.

A pre-fixing guide plate 12 guides the recording material P conveyed to the fixing device F from an image-forming mechanism side to an entrance portion of the fixing nip portion N. A separation claw 13 separates the recording material P from the fixing roller 1 by suppressing twisting of the recording material P that has exited the fixing nip portion N around the fixing roller 1. A post-fixing guide plate 14 discharges and guides the recording material P that has exited from an exit portion of the fixing nip portion N.

The above-described bobbin 4, the stay 7, and the separation claw 13 are formed of heat-resistant and electrically insulating engineering plastic.

A fixing roller drive gear G1 is fixed at a rear-side end portion of the fixing roller 1. The fixing roller 1 is rotationally driven in a clockwise direction indicated by arrow A in FIG. 2 at a circumferential speed of, in the present exemplary embodiment, 300 mm/sec based on the transmission of a rotational force from a drive source M1 via a transmission system to the fixing roller drive gear G1. The pressure roller 2 is driven and rotated in a counterclockwise direction indicated by arrow B by the rotational drive of the fixing roller 1 due to the frictional force with the fixing roller 1 at the fixing nip portion N.

A fixing roller cleaner 15 includes a cleaning web 15a, a web feeding axis portion 15b which holds the cleaning web 15a in a rolled shape, a web take-up axis portion 15c, and a pressing roller 15d for pressing the web portion between the axis portions 15b and 15c against the outer surface of the fixing roller 1. Offset toner on the surface of the fixing roller 1 is wiped off by the web portion pressed against the fixing roller 1 by the pressing roller 15d to clean the surface of the fixing roller 1. The web portion pressed against the fixing roller 1 is gradually renewed by feeding the web 15a little by little from the feeding portion 15b toward the take-up portion 15c.

In the present exemplary embodiment, sheet passing is performed based on a center reference, which is indicated by S. In the image forming apparatus according to the present exemplary embodiment, the maximum size of the recording material P that can be passed is, for example, A4 horizontal (297 mm). Further, the minimum size of the recording material P that can be passed is, for example, B5 R (182 mm). P1 is a sheet passing region width of that maximum size paper, and P2 is a sheet passing region width of the minimum size paper.

The thermistor 11, which is a center temperature detection member, is arranged pressing against the surface of the fixing roller 1, to face the coil 6 across the fixing roller 1 at a center portion of the fixing roller 1 corresponding roughly to a center portion of the sheet passing region width P2 of the minimum size paper. A temperature detection signal of the fixing roller 1 from the thermistor 11 is input to a controller (central processing unit (CPU)) 100.

The controller 100 in the image forming apparatus, in response to turning-on of a main power switch of the apparatus, activates the apparatus to start predetermined image forming sequence control. The fixing device F starts rotating the fixing roller 1 based on activation of the drive source M1. The pressure roller 2 is also driven and rotated by the rotation of the fixing roller 1. Further, the controller 100 flows a high-frequency current (e.g., 10 kHz to 100 kHz) to the coil 6 by activating a high-frequency inverter 101. Consequently, a high-frequency alternating magnetic flux is generated at the periphery of the coil 6, which causes the fixing roller 1 to produce electromagnetic inductive heat, so that the temperature increases toward a predetermined fixing temperature T. This increase in the temperature of the fixing roller 1 is detected by the thermistor 11, and that detected temperature information is input to the controller 100.

The controller 100 heats the fixing roller 1 by controlling the power supplied to the coil 6 from the high-frequency inverter 101 so that the detected temperature of the fixing roller 1 by the thermistor 11 is maintained at the predetermined fixing temperature (the image heating temperature) T, and performs temperature adjustment at the fixing temperature T. The controller 100 includes a function as a power-on control unit for controlling the power supplied to the coil 6.

In this temperature-adjusted state, the recording material P as the material to be heated, which carries the non-fixed toner image “t” from the image forming unit, is introduced into the fixing nip portion N, and sandwiched and conveyed through the fixing nip portion N. Consequently, the non-fixed toner image t is heated and fixed on a surface of the recording material P by the heat of the fixing roller 1 and the pressure applied by the fixing nip portion N.

In the first exemplary embodiment, when heating and fixing a sheet having a first grammage (a thickness) (e.g., 80 g/m²), the fixing temperature T in a plain paper mode as a first heating mode is set at 190° C. Further, when heating and fixing a thin sheet having a second grammage (thickness) (e.g., 60 g/m²), the fixing temperature T in a thin paper mode as a second heating mode is set at 170° C. The controller 100 includes a function as an execution unit capable of executing the plain paper mode and the thin paper mode.

Cooling fans 27a and 27b are cooling devices for cooling both end portions, approximately, of the fixing roller 1. The cooling fans 27a and 27b, which stop operating when passing sheets in the plain paper mode, are only operated by a (not illustrated) drive unit when passing thin sheets in the thin paper mode.

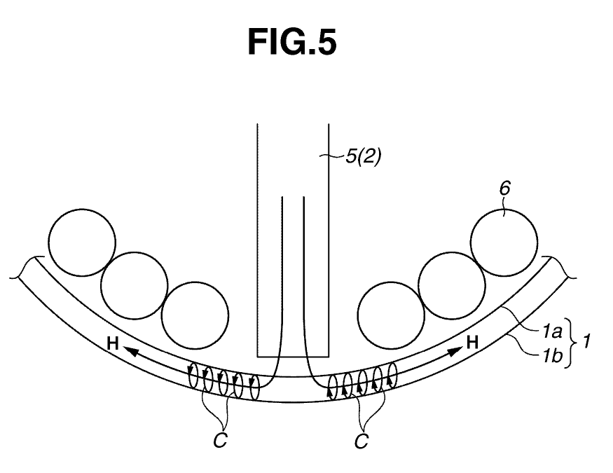

The principles of the electromagnetic induction heating of the fixing roller cored bar 1a, which is a conductive member, will now be described using FIG. 5. The magnetic flux indicated by arrow H is repeatedly produced and extinguished at the periphery of the coil 6 by the application of an alternating current from the high-frequency inverter 101 to the coil 6. The magnetic flux H is guided along a magnetic path formed by the cores 5 (1) and 5 (2) and the cored bar 1a. In response to changes in the magnetic flux H produced by the coil 6, an eddy current is generated in the cored bar 1a to generate magnetic flux in a direction that impedes changes in the magnetic flux H. This eddy current is indicated by arrow C.

This eddy current C flows in a concentrated manner onto a surface on the side of the coil 6 of the cored bar 1a due to skin effect, generating heat at a power that is proportional to surface resistance Rs of the cored bar 1a.

The skin depth δ (m) and surface resistance Rs (Ω) obtained from the frequency f (Hz) applied to the coil 6, the magnetic permeability μ (H/m) of the cored bar 1a, and the specific resistance ρ (Ω·m) of the cored bar 1a are represented by Formulae (1) and (2).

$$\begin{matrix}δ = \sqrt{\frac{ρ}{πμ f}} & ( 1 ) \\ Rs = \frac{ρ}{δ} = \sqrt{πμ f ρ} & ( 2 )\end{matrix}$$

Further, the eddy current I_{f}(A) induced in the cored bar 1a is represented by Formula (3) using the winding number N (times) of the coil 6 and the coil current I(A) applied to the coil 6, since the eddy current is proportional to the amount of magnetic flux passing through the cored bar 1a.

I_{f}∝NI (3)

Based on the above, the power W (W) generated in the cored bar 1a is represented by Formula (4), since the power is a function of the eddy current I_{f} induced in the cored bar 1a and the Joule heat produced by skin resistance.

W=Rs·I_{f}²∝\sqrt{μfρ}(NI)² (4)

It can be seen from Formula (4) that the heat generation amount of the cored bar 1a can be increased by using for the cored bar 1a a material having a high magnetic permeability and a high resistance, such as a ferromagnetic metal like iron or nickel or an alloy thereof, or by increasing the winding number of the coil 6.

Further, the high-frequency inverter 101 can optimally control the heat generation amount of the cored bar 1a by controlling the coil current I applied to the coil 6 or the frequency f of the coil current I.

Next, the Curie temperature Tc will be described. Generally, ferromagnetic materials no longer exhibit spontaneous magnetism when heated to a Curie temperature Tc that is specific to that material. Consequently, the magnetic permeability μ of a ferromagnetic material is roughly equal to its magnetic permeability μ₀ in a vacuum, and is thus constant. Therefore, if the temperature of the cored bar 1a, which is a conductive member in the fixing roller 1, exceeds the Curie temperature Tc, the heat generation amount W of the cored bar 1a decreases.

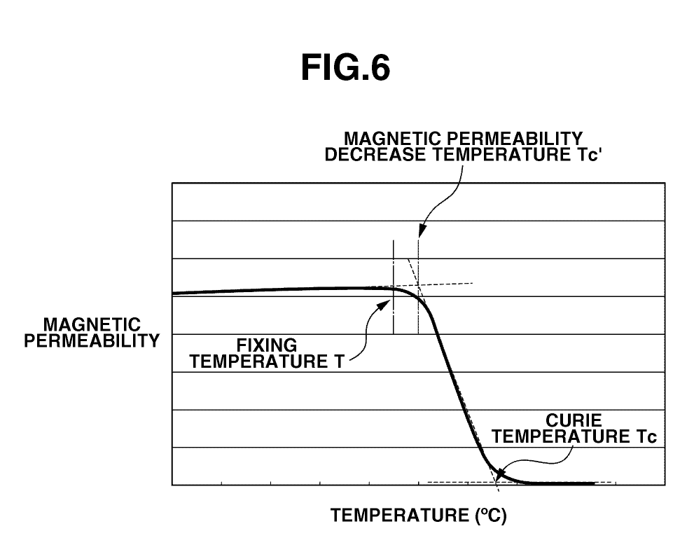

However, in actual practice, the magnetic permeability μ does not suddenly change around the Curie temperature Tc, rather, as illustrated in FIG. 6, the magnetic permeability μ starts to change from a magnetic permeability decrease temperature Tc′, which is lower than the Curie temperature Tc. More specifically, the magnetic permeability decrease temperature Tc′ is the temperature at which the maximum magnetic permeability value is exhibited. The magnetic permeability decrease temperature Tc′ of the cored bar 1a used in the first exemplary embodiment is 200° C., and the Curie temperature Tc is 220° C.

If the thickness of the cored bar 1a is t (m), when the temperature of the cored bar 1a increases and the skin depth δ of the cored bar 1a is equal to or greater than the thickness t of the cored bar 1a, the eddy current induced in the cored bar 1a flows across the entire cored bar 1a in a cross-sectional direction. The surface resistance Rs′ (Ω) and the heat generation amount W′ in this case are represented by Formulae (5) and (6).

$$\begin{matrix}{Rs}^{′} = \frac{ρ}{t} & ( 5 ) \\ {W}^{′} = {Rs}^{′} \cdot {If}^{2} ∝ \frac{ρ}{t} {( NI )}^{2} & ( 6 )\end{matrix}$$

In actual practice, the temperature of the cored bar 1a is fixed at a predetermined saturation temperature Ts when the relationship between the heat generation amount W′ represented by Formula (6) and the heat discharge Q (W) from the cored bar 1a satisfies the condition W′≦Q.

The heat discharge Q depends on the surface area and emissivity of the surface of the fixing roller 1, the temperature differences between the temperature of the surface of the fixing roller 1 and the temperature of the surrounding atmosphere and the pressure roller 2, and the heat transfer rate to the surrounding atmosphere and the pressure roller 2.

Thus, the temperature of the cored bar 1a is constant at the predetermined saturation temperature Ts by using a magnetic shunt alloy for the cored bar 1a in which the Curie temperature Tc is adjusted to be a predetermined temperature. More specifically, the predetermined temperature is higher than the fixing temperature T and lower than a permissive temperature, to which the temperature of the non-sheet passing portion can increase, and which is the heat resistance temperature of the fixing device. Consequently, the temperature of the non-sheet passing portion is constant even if a minimum size recording material is passed.

On the other hand, like in the above-described thin paper mode, when the fixing temperature T is sufficiently lower than the magnetic permeability decrease temperature Tc′ and the Curie temperature Tc, a situation may arise in which the temperature difference between the sheet passing portion and the non-sheet passing portion increases. This is because the heat generation amount of the non-sheet passing portion is basically the same as the heat generation amount of the sheet passing portion until the magnetic permeability decrease temperature Tc′ is exceeded, and only starts to decrease after the magnetic permeability decrease temperature Tc′ is exceeded.

Therefore, like in the above-described thin paper mode, when the fixing temperature T is even lower than the magnetic permeability decrease temperature Tc′ and the Curie temperature Tc, the temperature can quickly reach a constant level near the magnetic permeability decrease temperature Tc′ by increasing the above-mentioned heat discharge Q.

For example, as a conventional example, in the configuration according to the first exemplary embodiment, if the cooling fans 27a and 27b were not operated, the saturation temperature Ts of the non-sheet passing portion was 215° C. when A4 R paper sheets having a grammage of 80 g/m² were continuously passed in a plain paper mode (fixing temperature (first target temperature) is set to 190° C.). Although a temperature difference ΔT between the sheet passing portion and the non-sheet passing portion was 25° C., paper wrinkles and image defects such as scratched images did not occur on the fixed sheets. If the temperature difference ΔT is large, the thermal expansion coefficient of the fixing roller and the pressure roller is different between a center portion and the end portions. Consequently, the movement speed of the fixing roller and the pressure roller is different at the center portion and the end portions. If a recording material is conveyed in this state, wrinkles may form in the recording material because the speed at which the recording material is conveyed is different. However, in the present exemplary embodiment, since an increase in the temperature difference ΔT is suppressed in the manner described above, the formation of wrinkles in the recording material is suppressed.

The saturation temperature Ts of the non-sheet passing portion was 210° C. when A4 R paper sheets having a grammage of 60 g/m² were continuously passed in a thin paper mode (fixing temperature (second target temperature) is set to 170° C.). The temperature difference ΔT between the sheet passing portion and the non-sheet passing portion was 40° C., and scratched images occurred on the fixed sheets.

In contrast to the above-described conventional example, in the first exemplary embodiment, when the thin paper mode was selected, by operating the cooling fans 27a and 27b, the saturation temperature Ts of the non-sheet passing portion was 200° C. The temperature difference ΔT between the sheet passing portion and the non-sheet passing portion as 30° C., and paper wrinkles and image defects such as scratched images did not occur on the fixed sheets.

Specifically, in the configuration according to the first exemplary embodiment, since the heat discharge Q of the non-sheet passing portion in the fixing roller 1 is larger in the thin paper mode, which has a lower fixing temperature than the plain paper mode, than in the plain paper mode, the temperature of the non-sheet passing portion can be set lower than the saturation temperature Ts during the plain paper mode. Consequently, the temperature difference ΔT between the sheet passing portion and the non-sheet passing portion decreases, so that paper wrinkles and image defects such as scratched images can be improved even for thin sheets.

In the present exemplary embodiment, the temperature at an end portion of the fixing roller 1 is detected, and operation of the cooling fans is controlled so that cooling fan operation starts when the detected temperature reaches a pre-set temperature.

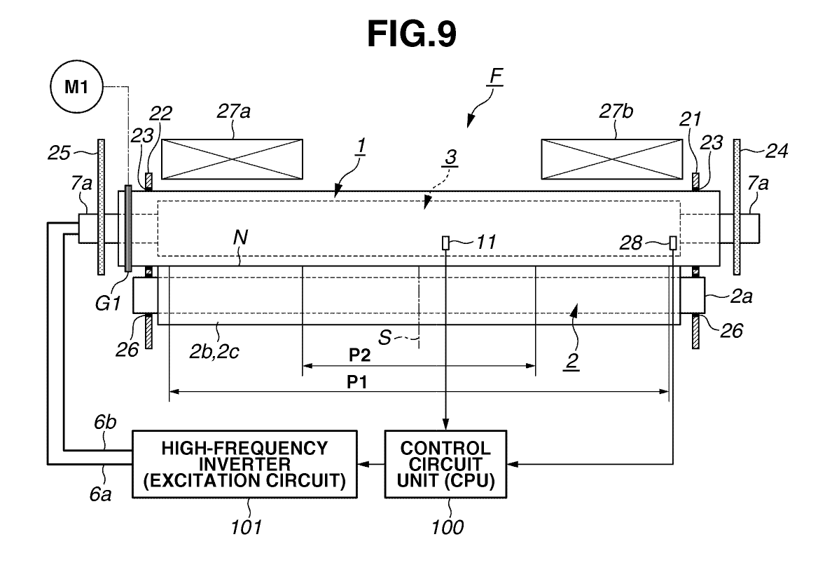

Specifically, in FIG. 9, a sub-thermistor 28 is arranged as an end portion temperature detection member (a temperature sensor) further out than the passing region width P1 of the maximum size sheet. Namely, the sub-thermistor 28 detects the temperature of the fixing roller 1 at a predetermined position on the end portion in a width direction. Further, when the sub-thermistor 28 reaches the pre-set temperature, the cooling fans 27a and 27b are operated.

In the present exemplary embodiment, when a minimum size sheet is passed in a passing mode in which the difference between the fixing temperature and the Curie temperature is large, like the thin paper mode, since the temperature difference from the fixing temperature to the magnetic permeability decrease temperature is large, the increase in the temperature of the non-sheet passing portion at that region is large. Consequently, in the present exemplary embodiment, in the passing mode in which the difference between the fixing temperature and the Curie temperature is large, by operating the cooling fans 27a and 27b at a temperature between the fixing temperature and the magnetic permeability decrease temperature, the increase in temperature at a region where the temperature increase is large is suppressed, so that the temperature difference ΔT between the sheet passing portion and the non-sheet passing portion is reduced.

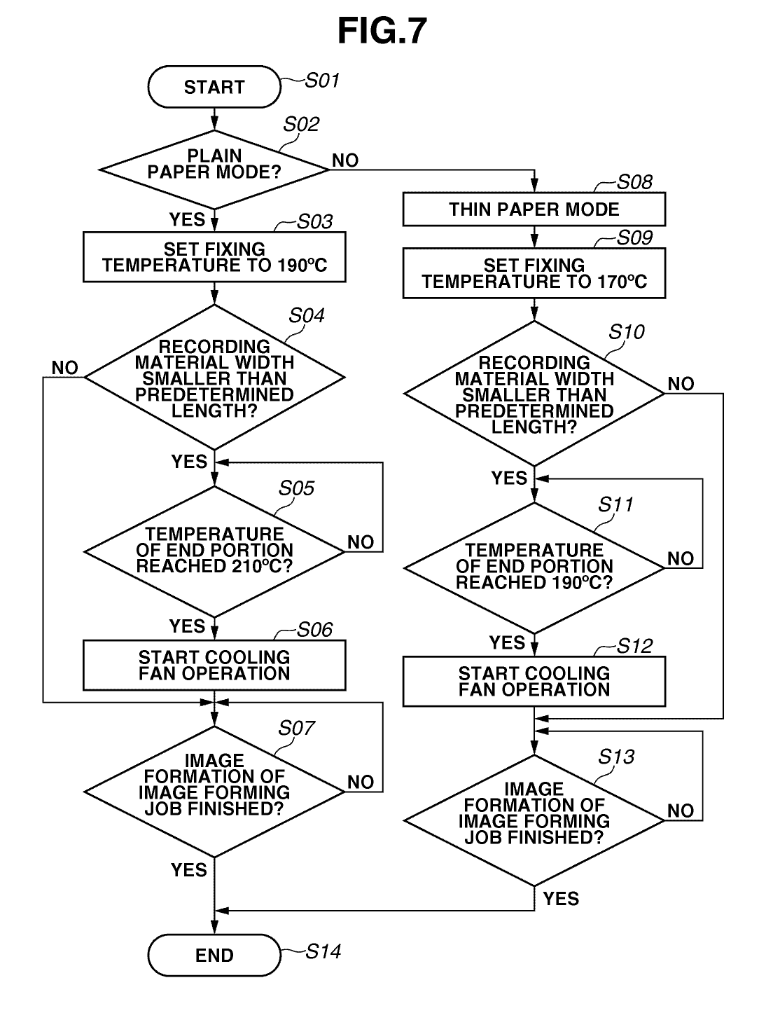

Next, the operation of the cooling fans 27a and 27b according to the present exemplary embodiment will now be described with reference to the flowchart illustrated in FIG. 7.

In the present exemplary embodiment, the image forming apparatus includes two modes, the plain paper mode and the thin paper mode. Obviously, the image forming apparatus may include other modes.

In step S01, the processing flow starts when an image formation job is input. Then, in step S02, the controller 100 determines whether the image formation job is the plain paper mode. If it is determined that the image formation job is the plain paper mode (YES in step S02), the processing proceeds to step S03, and if it is determined that the image formation job is not a plain paper mode (NO in step S02), the processing proceeds to step S08. In step S03, for the plain paper mode, the controller 100 sets the fixing temperature to 190° C. Next, in step S04, the controller 100 determines whether the width of the recording material is smaller than a predetermined length. If it is determined that the width of the recording material is smaller than a predetermined length (YES in step S04), an image forming operation starts based on the assumption that the recording material can be passed. Then, in step S05, the controller 100 determines whether the temperature of the end portion during the image forming operation has reached 210° C. Specifically, the controller 100 determines whether the sub-thermistor 28 has detected a first non-sheet passing portion temperature (a first set temperature) (210° C.). If it is determined that the end portion temperature has reached 210° C. (YES in step S05), the processing proceeds to step S06. In step S06, the controller 100 operates the cooling fans 27a and 27b. Then, in step S07, the controller 100 determines whether image formation in the image formation job is finished. If it is determined that image the formation has finished (YES in step S07), the processing proceeds to step S14, and the processing ends. If it is determined in step S04 that the width of the recording material is longer than the predetermined length (NO in step S04), the cooling fans 27a and 27b are not operated, and the processing proceeds to step S07.

On the other hand, if it is determined in step S02 that the image formation job is not the plain paper mode (NO in step S02), the processing proceeds to step S08, where, in the present exemplary embodiment, the thin paper mode is selected. Instep S09, for the thin paper mode, the controller 100 sets the fixing temperature to 210° C. Next, in step S10, the controller 100 determines whether the width of the recording material is smaller than a predetermined length. If it is determined that the width of the recording material is smaller than the predetermined length (YES in step S10), an image forming operation starts based on the assumption that the recording material can be passed. Then, in step S11, the controller 100 determines whether the temperature of the end portion during the image forming operation has reached 190° C. (second set temperature). Specifically, the controller 100 determines whether the sub-thermistor 28 detects a first non-sheet passing portion temperature (190° C.). If it is determined that the end portion temperature has reached 190° C. (YES in step S11), the processing proceeds to step S12. In step S12, the controller 100 operates the cooling fans 27a and 27b. Then, in step S13, the controller 100 determines whether the image formation in the image formation job is finished. If it is determined that the image formation is finished (YES instep S13), the processing proceeds to step S14, and the processing ends. If it is determined in step S10 that the width of the recording material is longer than the predetermined length (NO in step S10), the cooling fans 27a and 27b are not operated, and the processing proceeds to step S13.

According to the configuration of the present exemplary embodiment, when sheets are continuously passed in the plain paper mode (fixing temperature is set at 190° C.), if the sub-thermistor 28 detects the first non-sheet passing portion temperature (210° C.), by operating the cooling fans 27a and 27b, the temperature of the non-sheet passing portion (the saturation temperature) is fixed at around 220° C. On the other hand, when sheets are continuously passed in the thin paper mode (fixing temperature is set at 170° C.), the temperature of the non-sheet passing portion (the saturation temperature) is fixed at around 200° C.

In the present exemplary embodiment, the cooling fans 27a and 27b were operated even in the plain paper mode. The purpose of this was to reduce the difference between the sheet passing portion temperature and the non-sheet passing portion temperature as much as possible. However, since the difference between the fixing temperature and the Curie temperature in the plain paper mode is not great enough to cause conveyance problems with the recording material, the cooling fans do not have to be operated.

Thus, according to the present exemplary embodiment, since the temperature of the non-sheet passing portion can be set lower than the saturation temperature during the plain paper mode, the temperature difference between the sheet passing portion and the non-sheet passing portion decreases, so that paper wrinkles and image defects such as scratched images can be improved even for thin sheets. Further, in the present exemplary embodiment, the difference between the saturation temperature (200° C.) and the fixing temperature (170° C.) in the thin paper mode is 30° C., and the difference between the saturation temperature (220° C.) and the fixing temperature (190° C.) in the plain paper mode is 30° C. Specifically, the temperature difference between the saturation temperature and the fixing temperature is the same in the thin paper mode and the plain paper mode.

A second exemplary embodiment will now be described. The present exemplary embodiment is characterized by including a device for detecting the current or voltage induced in a detection coil arranged facing the coil as a magnetic permeability detection unit configured to detect changes in the magnetic permeability of a cored bar in a fixing roller acting as a heating member.

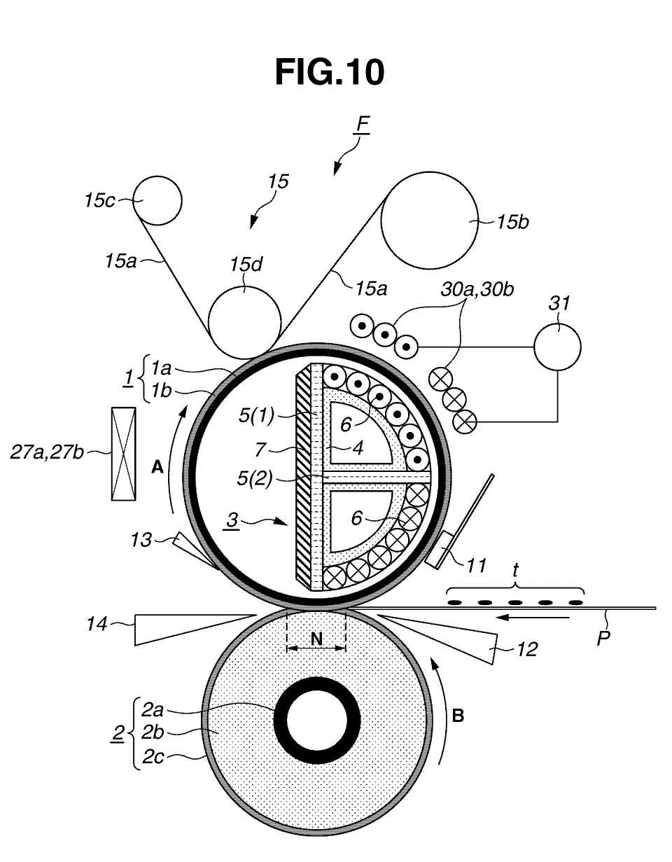

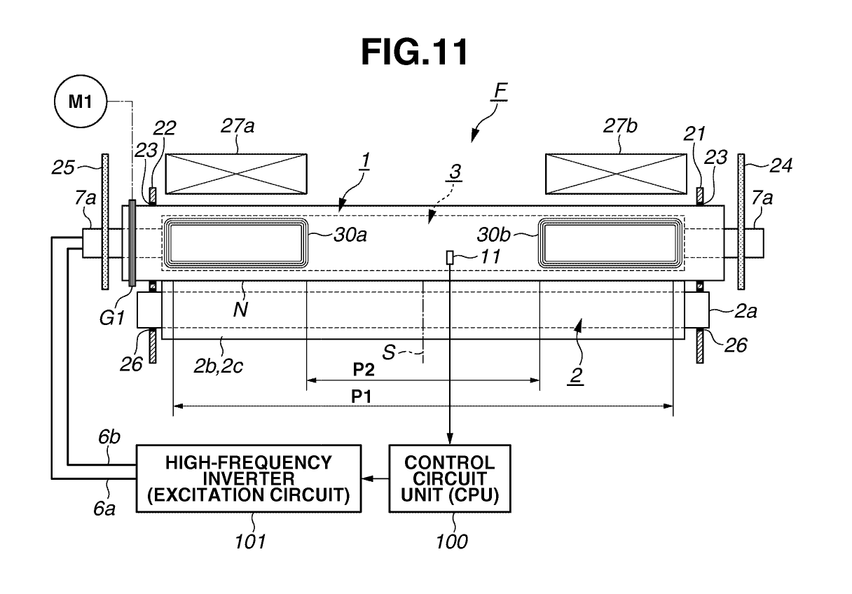

Specifically, in FIG. 10, a detection coil 30 (30a and 30b) is arranged facing a coil 6 to surround a cored bar 1a. Further, the image heating device F includes an ammeter 31 as a current detection unit for measuring the induced current induced in the detection coil 30. The detection coil 30 and the ammeter 31 together form a closed circuit. The detection coil 30 is held by a (not illustrated) holder to maintain a predetermined space from the surface of the fixing roller 1. The remaining configuration is the same as the above-described first exemplary embodiment. As illustrated in FIG. 11, the detection coil 30 is arranged further out than the minimum size sheet passing region P2.

Next, a method for detecting changes in the magnetic permeability of the cored bar 1a in the second exemplary embodiment will be described. If the temperature of the cored bar 1a adjusted to a predetermined Curie temperature Tc increases and exceeds the magnetic permeability decrease temperature Tc′, the magnetic permeability of the cored bar 1a decreases, and the skin depth δ represented by Formula (1) increases. If the skin depth δ exceeds the thickness t of the cored bar 1a, among the magnetic flux produced by the coils 6a and 6b, the amount leaking out from the cored bar 1a suddenly increases.

Magnetic flux that is leaked out from the cored bar 1a passes through the detection coil 30 arranged facing the coils 6a and 6b. Therefore, an induced current proportional to the amount of leaked magnetic flux flows in the detection coil 30 in a direction cancelling the magnetic flux that is leaked out from the cored bar 1a.

Consequently, the changes in the magnetic permeability of the cored bar 1a can be detected based on an output from the ammeter 31 that is connected to the detection coil 30.

In addition to the operation of the cooling fans 27a and 27b in the thin paper mode and the plain paper mode of the first exemplary embodiment, the second exemplary embodiment adds another cooling fan operation. Specifically, when the ammeter 31 detects a predetermined value or greater, by operating the cooling fans 27a and 27b, the heat discharge of the non-sheet passing portion is increased, which enables the saturation temperature Ts of the non-sheet passing portion to be decreased.

The embodiment of the heating member is not limited to a roller body. Some other rotating body embodiment, such as an endless belt, may also be employed. Further, the heating member may be configured as a single conductive member, which is an induction heating body, or as a composite member, which is formed from two or more layers, including a conductive member layer, of some other material such as a heat-resistant elastic resin or a ceramic.

The induction heating of the conductive member performed by the magnetic flux generation unit is not limited to an internal heating method. A device configuration can be employed that uses an external heating method in which the magnetic flux generation unit is arranged externally to the conductive member. Further, the temperature detection members 11 and 28 are not limited to a thermistor. The temperature detection members 11 and 28 may be a contact type or a non-contact type.

In the above exemplary embodiments, cooling fans are used as a cooling device. However, the cooling device is not limited to the cooling fan configuration. For example, other than a cooling fan, a heat dissipating roller configured from a high thermal conductivity material may be used as the cooling devices 27a and 27b. In this case, the heat dissipating roller can be made to contact the fixing roller 1 or be separated from the fixing roller 1 by a (not illustrated) contact mechanism. For example, in the plain paper mode, the heat dissipating roller is separated from the fixing roller 1, and in the thin paper mode, the heat dissipating roller contacts the fixing roller 1. Consequently, in the thin paper mode, the heat discharge of the fixing roller 1 is increased, so that the saturation temperature Ts of the non-sheet passing portion can be decreased. This enables the occurrence of paper wrinkles and image defects such as scratched images to be suppressed even if thin sheets having the minimum size are continuously passed.

Similarly, a Peltier element may be used as the cooling device. In this case, in the plain paper mode, power is not supplied to the Peltier element, while in the thin paper mode, power is supplied to the Peltier element.

Further, although the fixing roller 1 is directly cooled by the cooling fans 27a and 27b in the first exemplary embodiment, the heat discharge of the fixing roller 1 may be increased by cooling some other member in contact with the fixing roller 1 to increase the temperature difference therebetween.

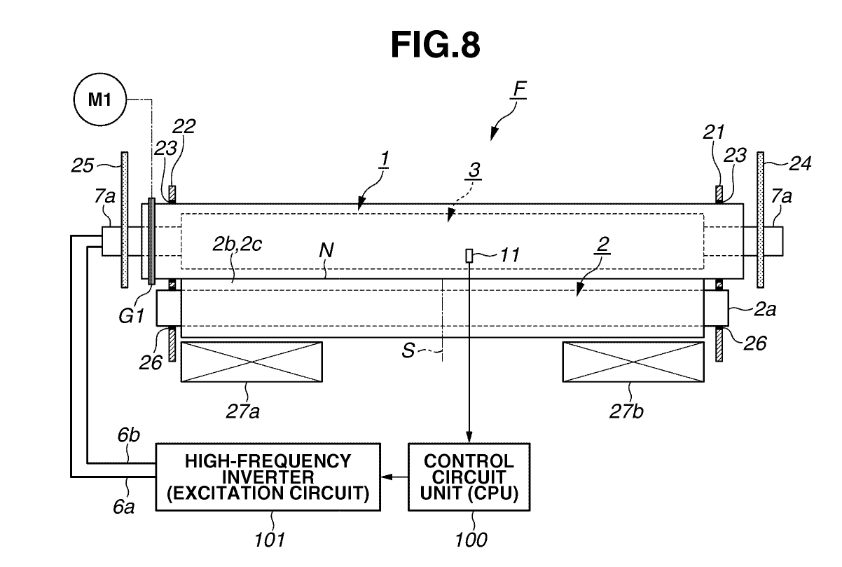

As illustrated in FIG. 8, as an example of a member contacting the fixing roller 1, the cooling fans 27a and 27b may cool the pressure roller 2. In this case, the saturation temperature Ts of the non-sheet passing portion can be decreased by indirectly increasing the heat discharge of the fixing roller 1 by increasing the temperature difference between the fixing roller 1 and the pressure roller 2 by cooling the non-sheet passing portion of the pressure roller 2. This enables the occurrence of paper wrinkles and image defects such as scratched images to be suppressed even if thin sheets having the minimum size are continuously passed.

In addition, the cooling effect from the cooling device may be differentiated in the plain paper mode and the thin paper mode. For example, in the first exemplary embodiment illustrated in FIG. 2, in the thin paper mode the cooling fans 27a and 27b may be operated at a constant speed, and in plain paper mode the cooling fans 27a and 27b may be operated at half speed.

Moreover, although the first exemplary embodiment includes the plain paper mode and the thin paper mode in which the fixing temperature is lower than in the plain paper mode, the fixing temperature setting is not limited to this. For example, in addition to the plain paper mode and the thin paper mode, a thick paper mode may also be provided as a third mode in which the fixing temperature T is higher than in the plain paper mode.

Still further, in the first exemplary embodiment, although the plain paper mode and the thin paper mode in which the fixing temperature is lower than in the plain paper mode are exemplified as modes having a different fixing temperature, the present invention is not limited to this as long as the modes have different fixing temperatures. For example, the present invention can be similarly applied in a heating device for heating and fixing full color images that has a full color mode and a monochrome mode in which the fixing temperature is lower than in the full color mode.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-247814 filed Nov. 11, 2011, which is hereby incorporated by reference herein in its entirety.

What is claimed is:

1. An image heating device comprising:
a coil;
an image heating member configured to generate heat by magnetic flux generated from the coil to heat an image on a recording material at a nip portion,
wherein the image heating member includes a magnetic shunt alloy adjusted to have a predetermined Curie temperature;
a nip forming member configured to form the nip portion with the image heating member;
a controller configured to execute a first heating mode for heating a recording material having a first grammage at a first target temperature, which is lower than the Curie temperature, when the recording material having the first grammage is conveyed to the nip portion, and to execute a second heating mode for heating a recording material having a second grammage, which is less than the first grammage, at a second target temperature, which is lower than the first target temperature, when the recording material having the second grammage is conveyed to the nip portion; and
a cooling device configured to cool an end portion of the nip forming member,
wherein, in the first heating mode, the cooling device is stopped by the controller, and, in the second heating mode, if a predetermined recording material with a width narrower than a maximum width that is usable by the image heating device is conveyed to the nip portion, the cooling device is operated by the controller when a temperature at a predetermined position at an end portion of the image heating member reaches a pre-set temperature that is lower than the Curie temperature.

2. The image heating device according to claim 1, wherein the pre-set temperature is lower than a temperature at which a magnetic permeability value is at a maximum with respect to the temperature.

3. The image heating device according to claim 1, wherein the image heating member includes a magnetic shunt alloy adjusted to have the Curie temperature.

4. The image heating device according to claim 1, wherein the cooling device is configured to cool both end portions in a width direction of the image heating member.

5. The image heating device according to claim 1, wherein the cooling device includes a fan.

6. The image heating device according to claim 1, further comprising an end portion temperature sensor configured to detect a temperature at a predetermined position at the end portion of the image heating member.

7. An image heating device comprising:
a coil;
an image heating member configured to generate heat by magnetic flux generated from the coil to heat an image on a recording material at a nip portion,
wherein the image heating member includes a magnetic shunt alloy adjusted to have a predetermined Curie temperature;
a nip forming member configured to form the nip portion with the image heating member;
a controller configured to execute a first heating mode for heating a recording material having a first grammage at a first target temperature, which is lower than the Curie temperature, when the recording material having the first grammage is conveyed to the nip portion, and to execute a second heating mode for heating a recording material having a second grammage, which is less than the first grammage, at a second target temperature, which is lower than the first target temperature, when the recording material having the second grammage is conveyed to the nip portion; and
a cooling device configured to cool an end portion of the nip forming member,
wherein, in the first heating mode, if a recording material having a width narrower than a maximum width that is usable by the image heating device is continuously conveyed to the nip portion, the cooling device operates when a temperature at a predetermined position at an end portion of the image heating member reaches a pre-set first setting temperature, which is lower than the Curie temperature, and, in the second heating mode, if a recording material having a width narrower than the maximum width that is usable by the image heating device is continuously conveyed to the nip portion, the cooling device operates when the temperature at the predetermined position at the end portion of the image heating member reaches a second setting temperature, which is lower than the first setting temperature.

8. The image heating device according to claim 7, wherein the first temperature is lower than a temperature at which a magnetic permeability value is at a maximum with respect to the temperature.

9. The image heating device according to claim 7, wherein the image heating member includes a magnetic shunt alloy adjusted to have the Curie temperature.

10. The image heating device according to claim 7, wherein the cooling device is configured to cool both end portions in a width direction of the image heating member.

11. The image heating device according to claim 7, further comprising an end portion temperature sensor configured to detect the temperature at the predetermined position at the end portion of the image heating member.

12. The image heating device according to claim 7, wherein a difference between the first target temperature and the first setting temperature is equal to a difference between the second target temperature and the second setting temperature.
